(19) United States
(12) Patent Application Publication
(10) Pub. No.: US 2011/0062695 A1
(43) Pub. Date: Mar. 17, 2011

(54) MOBILE WORK DEVICE WITH STABILITY MONITORING SYSTEM

(75) Inventors: Dieter Bergemann, Rosengarten (DE); Stephan Gelies, Magdeburg (DE); Thorsten Haefner, Nuertingen (DE); Michael Neubert, Aichtal (DE)

(73) Assignee: Putzmeister Engineering GmbH, Aichital (DE)

(21) Appl. No.: 12/736,828

(22) PCT Filed: Mar. 31, 2009
(86) PCT No.: PCT/EP2009/053765

§ 371 Date: Nov. 12, 2010

(30) Foreign Application Priority Data
May 21, 2008 (DE) 10 2008 024 612.3
Jun. 24, 2008 (DE) 10 2008 029 705.4
Nov. 25, 2008 (DE) 10 2008 058 937.3

(51) Int. Cl. B60S 9/12; B66C 23/78

(52) U.S. Cl. 280/763.1

(57) ABSTRACT

A mobile implement, particularly an automatic concrete pump, with stability monitoring system includes an undercarriage supportable on a subsurface by two front and two rear outriggers. A respective measuring element is disposed in the telescoping support legs of the outriggers for determining the supporting force. Each support leg has an upper telescoping element connected to the associated outrigger at an upper connection point, and a support base displaceable relative to the upper element and supported on the subsurface at the lower end thereof at a lower connection point. The measuring element is disposed either directly at the upper connection point between the outrigger and the upper telescoping element, or in the region of the lower connection point between the lower telescoping element and the support base.

The invention relates to a mobile work device, particularly a mobile concrete pump, having a chassis, having two front and two rear support outriggers that can be moved out from a travel position into at least one support position, and can be supported on a subsurface by means of a telescoping support leg, in each instance, while raising the chassis, and having a measuring element, in each instance, for determining the supporting force in the support legs, whereby the support legs have an upper telescoping element, in each instance, connected with the related support outrigger at an upper connection point, and a lower telescoping element, in each instance, connected with a support foot that can be supported on the subsurface, at a lower connection point, at its lower end, which lower element is displaceable relative to the upper element.

Mobile work devices of this type are provided with extendable support outriggers that are supposed to improve the stability of the work device at the connection point of use. In this connection, the support outriggers have the task, on the one hand, of eliminating the vehicle suspension and raising the wheels from the subsurface. For another thing, the support outriggers are supposed to reduce the risk of tipping, which results if high tipping moments occur by way of a work boom. The support legs of the support outriggers form the corners of a quadrangle, the side lines of which circumscribe an area within which the overall center of gravity of the work device must lie, in order to guarantee its stability. Since the extending work boom can rotate, the overall center of gravity describes a full circle during a rotation, which circle must lie within the quadrilateral area, in the work range of the work boom. Since space conditions on construction sites are limited, full support is often waived. This limits the pivot range of the work boom.

In order to guarantee tipping safety, a monitoring device has already been proposed (“Beton” [Concrete] magazine, 6/96, pages 362, 364). There, the pressures that prevail in the four hydraulically activated telescopes of the support legs are monitored. If the pressure in two support leg cylinders decreases, the mast movements and the concrete pump are shut off. This technique can also be used in the event that a machine is not fully supported for space reasons. However, studies have shown that pressure measurements in the telescoping cylinders of the support legs are not sufficient for reliable support leg monitoring. This particularly holds true if one of the support cylinders has been moved to its end position. Dynamic support effects also cannot be detected using this monitoring system.

In order to avoid these disadvantages, it has already been proposed (DE-A 101 10 176) that a pair of force sensors is disposed in the foot part of every support leg. Each force sensor there is disposed in an electrical measurement circuit for giving off a support-load-dependent measurement signal, whereby the monitoring device comprises evaluation electronics that can have the support-foot-related support load measurement values and, for a comparison, at least one predetermined stability-determining threshold value applied to them. The evaluation electronics comprise a software routine for determining the second-lowest support-foot-related support load measurement value of each scanning cycle, and for comparing it with a stability-determining threshold value.

Furthermore, it is known, in the case of a mobile work device of the type indicated initially (DE-A 103 49 234), that in the case of support outriggers in which the telescoping support legs are articulated onto a support leg box with a telescoping element that is fixed in place on the outrigger, by means of a wrist pin, the wrist pin is configured as a measuring element for determining the support load. In this connection, the elastic bending of the wrist pin can be used as a measure for the support-leg-related support load, for one thing. In this case, the wrist pin carries at least one strain gauge for determining the pin bending. Another possibility consists in that the elastic shear deformation that occurs in the region of the bearing points of the wrist pin is used as a measure for the support-leg-related support load. In this case, the wrist pin carries at least one strain gauge in the region of its bearing points, to determine the shear deformation. Comparison measurements with force measurements that were recorded directly at the foot plate have shown that in the case of supporting force measurement using the arrangements described, systematic incorrect measurements can occur, which oppose reliable stability monitoring.

Proceeding from this, the invention is based on the task of improving the support design of the known work devices, to the effect that a precise measurement of supporting force is possible.

In order to accomplish this task, the combination of characteristics indicated in claims 1 and 8 is proposed. Advantageous embodiments and further developments of the invention are evident from the dependent claims. The solution according to the invention is based on the recognition that in the case of the force transfer systems for supporting force measurement that are disposed within the support legs, friction forces occur, which lead to a distortion of the measurement at the measurement location. In other words, force paths for the force transfer occur there, which paths do not run by way of the actual measurement location. It is therefore the goal of the invention to eliminate friction forces within the force transfer system, in that the parts of the force transfer system that move relative to one another are mounted to float relative to one another.

In order to make this possible, it is proposed, according to the invention, in an embodiment variant in which the measuring element is disposed in the region of the upper connection point between the support outrigger and the upper telescoping element, that the upper telescoping element lies axially against a force introduction location of the measuring element with radially centered play, by means of a pressure piece in a sleeve-shaped accommodation that is disposed on the support outrigger and faces downward, under the effect of the supporting force. It is particularly advantageous, in this connection, if the accommodation has a sheathing pipe that is rigidly connected with the support outrigger, in which pipe the upper telescoping element is axially displaceable, in unhindered manner, with radially centered play. A preferred embodiment of the invention provides that the radial play between sheathing pipe and upper telescoping element is bridged by means of at least two elastically deformable support rings disposed at an axial distance from one another, which bring about the centering.

It is particularly advantageous if the telescoping element lies against the force introduction location with spring-centered play, by way of the pressure piece in the sleeve-shaped accommodation. In this connection, the support rings can be spring-elastically deformable. It is advantageous if the spring-elastically deformable support rings are shaped in the manner of a zigzag, a lamella, or a meander, and/or are slit, in the circumference direction.

It is advantageous if the upper telescoping element is articulated onto the support outrigger, with its pressure piece disposed on its upper face side, by means of a wrist pin that passes through the accommodation or the sheathing pipe transverse to the telescope axis, whereby the wrist pin is configured as a measuring element. For this purpose, the wrist pin has at least one strain gauge for determining the pin bending or the shear deformation as a measure for the supporting force.

A further improvement in the friction-free supporting force transfer system is achieved in that the pressure piece and the upper telescoping element are axially coupled with one another at face-side coupling surfaces that are complementary to one another and curved in spherical shape. A further improvement in this regard is achieved if the lower telescoping element carries a support foot ball that projects downward, while the foot part has a bearing socket to accommodate the support foot ball. Alternatively to this, in the sense of a kinematic inversion, the foot part can carry a support foot ball that projects upward, while the lower telescoping element has a bearing socket to accommodate the support foot ball.

According to a second preferred embodiment variant of the invention, in which the measuring element is disposed in the region of the lower connection point between the lower telescoping element and the support foot, it is proposed, according to the invention, that the support foot lies axially against a force introduction location of the measuring element, with radially centered play, with a pressure piece in an accommodation disposed on the lower telescoping element, under the effect of the supporting force. In this connection, it is advantageous if the accommodation has a measuring bell that is rigidly connected with the lower telescoping element, while the foot part has a support foot ball mounted in a bearing socket, whereby the pressure piece is formed onto either the support foot ball or the bearing socket. The pressure piece engages into the measuring bell from below, with radial play, and there lies axially against the measuring element under the effect of the supporting force, and is secured to prevent it from falling out. The radial play between pressure piece and measuring bell is bridged, in this embodiment, as well, by means of at least two elastically deformable support rings disposed at an axial distance from one another, which bring about the centering. In this connection, it is practical if the support rings are spring-elastically deformable, for example in that they are shaped in the manner of a zigzag, a lamella, or a meander, and/or are slit, in the circumference direction. In order to prevent the pressure piece from falling out of the measuring bell, in undesirable manner, the pressure piece has a circumferential groove that is partly penetrated by two securing pins that lie diametrically opposite one another and are supported on the measuring bell. The force measurement takes place using a measuring element that has at least one force sensor to which the supporting force is applied by way of the pressure piece.

In order to achieve a compact method of construction, it is proposed, according to a preferred embodiment of the invention, that the measuring element additionally has internal and/or external measurement electronics, which are either connected with power supply and signal lines that are passed to the outside, or that have a transmitter or a transmission receiver for wireless measurement value transmission. In order to protect the lower telescoping element from contamination, it is advantageous if this element is covered by a spiral-shaped folded bellows in which the lines for the power supply and/or the signal transmission can be integrated. Fundamentally, however, a wireless power supply, for example an inductive power supply, is also possible.

Another preferred embodiment of the invention provides that each measuring element has two redundant force sensors with measurement electronics and transmitter(s) for data transmission. In order to avoid an external power supply, each measuring element or each redundant force sensor with measurement electronics can have a rechargeable battery assigned to it. Simple charging of the battery is made possible in that an inductive power supply segment connected with an alternating current source on the primary side and with the battery, by way of a charging circuit, on the secondary side, is disposed between the telescoping elements of the support legs, which segment has a primary and a secondary coil that is disposed on one of the telescoping elements, in each instance, and is activated only in the retracted state of the telescoping elements.

The telescoping cylinder of the support leg is preferably configured as a cylinder part of a dual-action hydrocylinder, the piston of which is connected with a piston rod that forms the other telescoping element. It is advantageous if the upper telescoping element forms the cylinder part and the lower telescoping element forms the piston rod of the hydrocylinder.

In the following, the invention will be explained in greater detail using an exemplary embodiment shown schematically in the drawing. This shows:

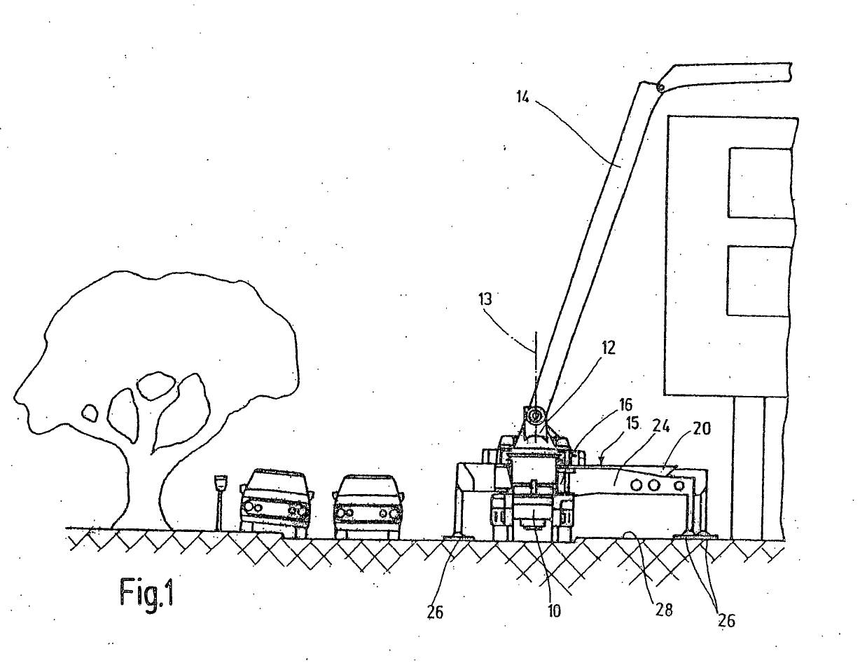

FIG. 1 a view of a mobile concrete pump parked at the edge of a road, with support outriggers providing narrow support on the road side;

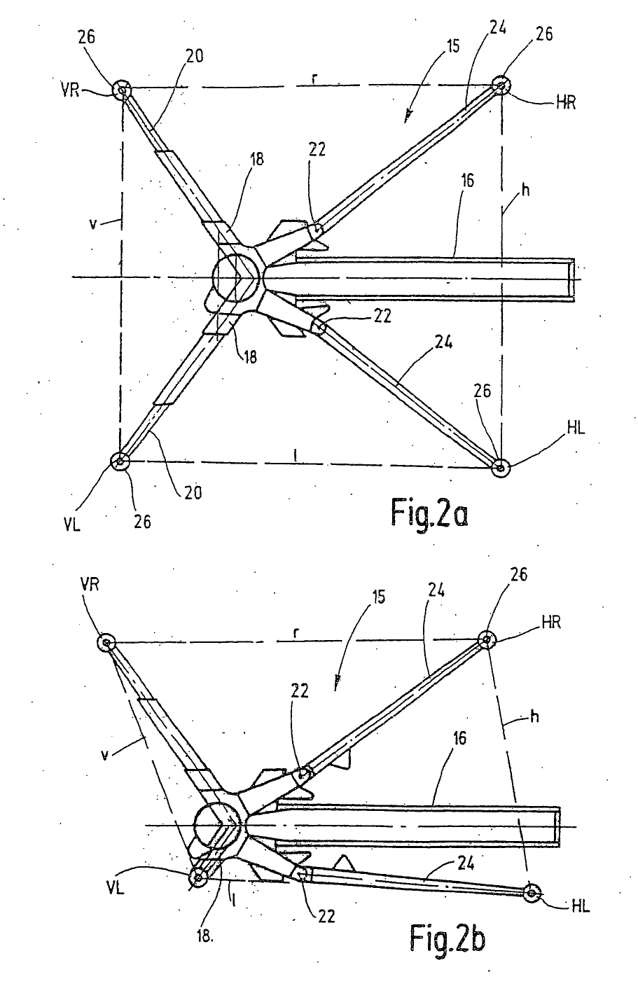

FIGS. 2a and b a top view of the support construction of the mobile concrete pump according to FIG. 1, in the state of full support and one-sided narrow support;

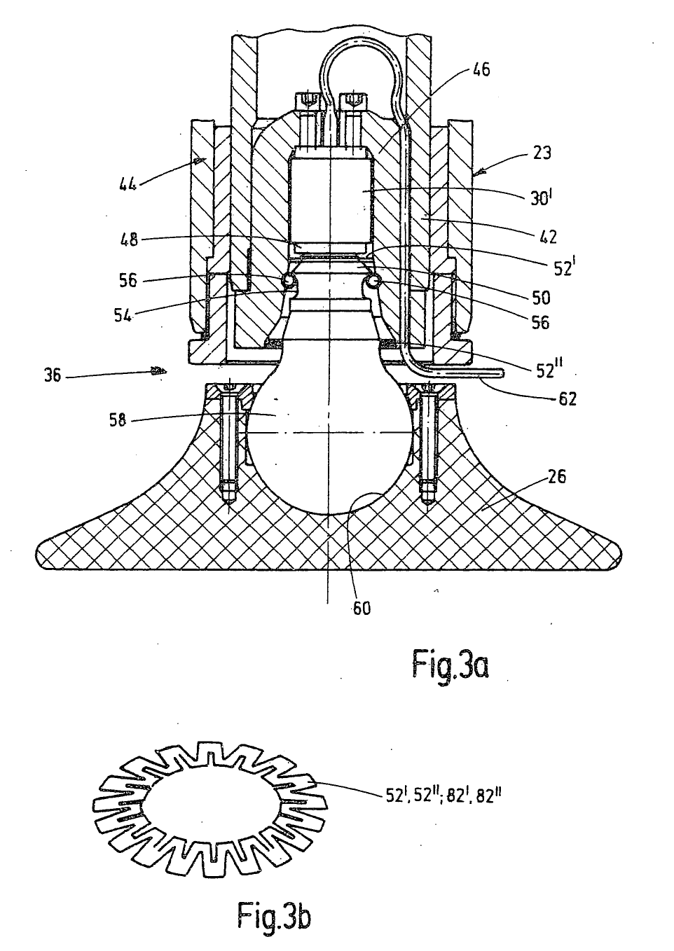

FIG. 3a a detail of a support foot of a support outrigger with a first embodiment variant of a measuring element, in a sectional representation;

FIG. 3b a diagrammatic representation of a support ring;

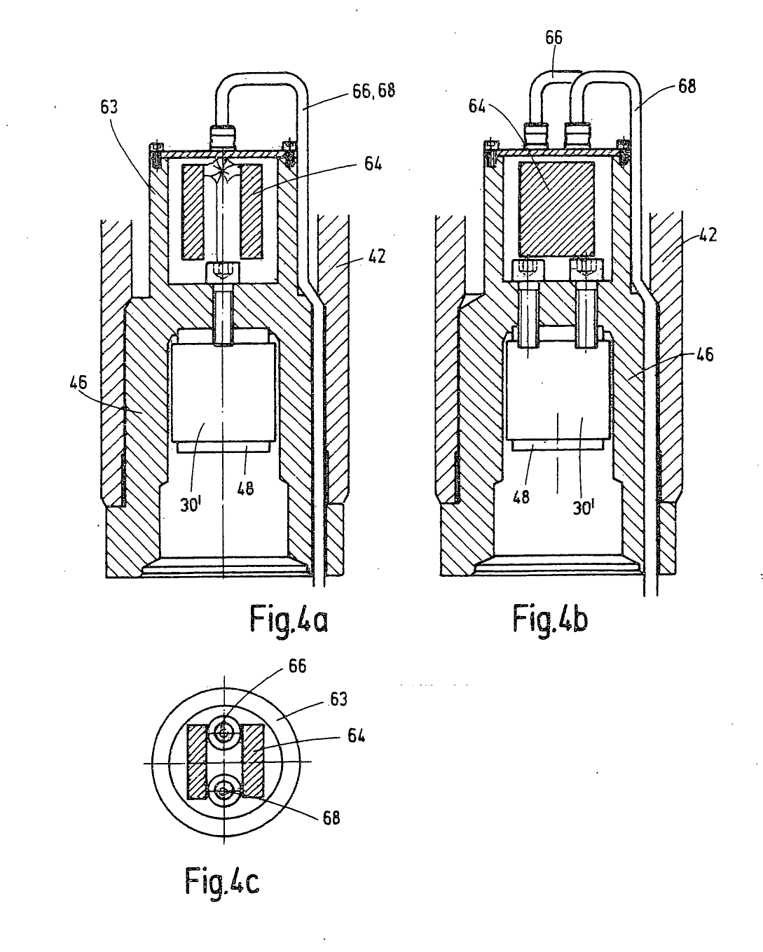

FIG. 4a to c two longitudinal sections through the measuring element part of an exemplary embodiment of a support foot, modified as compared with FIG. 3a, with integrated measurement electronics, as well as a cross-section through the measurement electronics housing according to FIG. 4a;

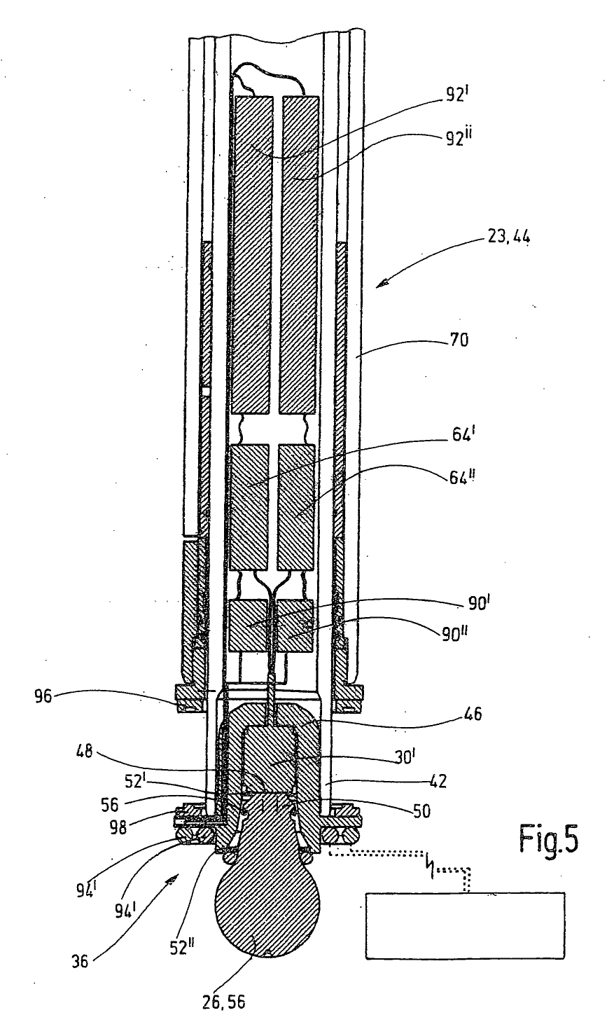

FIG. 5 a longitudinal section through the measuring element part of an exemplary embodiment of a support leg with integrated measurement electronics and power supply unit, modified as compared with FIGS. 3a and 4a to c;

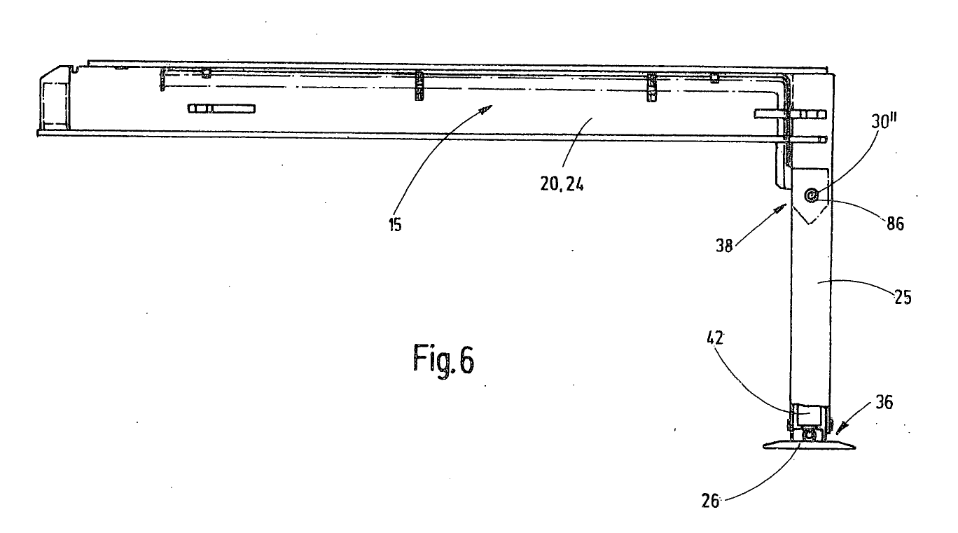

FIG. 6 a side view of a support outrigger with a second embodiment variant of a measuring element for the supporting force measurement;

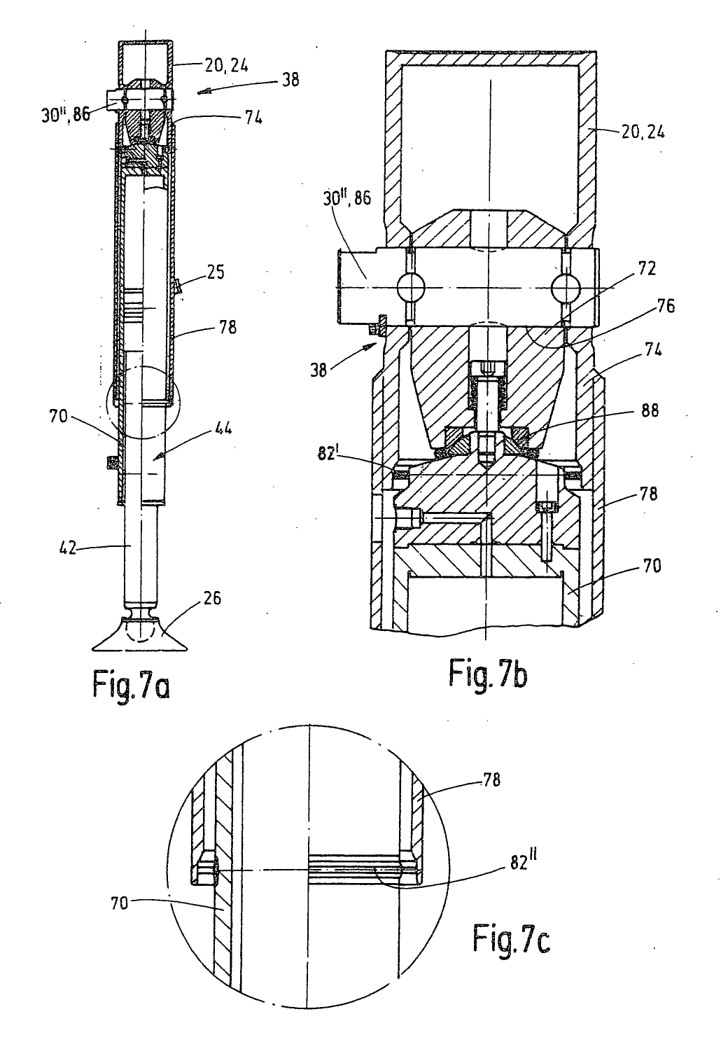

FIG. 7a a longitudinal section through the support leg of the support outrigger according to FIG. 6;

FIGS. 7b and c enlarged details from FIG. 7a.

The mobile concrete pump shown in FIG. 1 essentially consists of a multi-axle chassis 10, a concrete distributor mast 14 mounted to rotate about a vertical axle 13, which is fixed in place on the chassis, on a mast base 12 located close to the front axle, and a support construction 15 that has a support frame 16 fixed in place on the chassis, two front support outriggers 20 that can be displaced on the support frame 16, each in a telescoping segment 18 configured as an extension box, and two rear support outriggers 24 that can pivot about a vertical axis 22. The support outriggers 20, 24, at their support legs 23, 25, can each be supported on the subsurface 28 with a support foot 26 that can be moved out downward. The front and rear support outriggers 20, 24 can be moved out using hydraulic means, from a driving position close to the chassis, to a support position. In the example shown in FIG. 1, a narrow support was chosen on the road side. The narrow support, which can be used to take space problems on construction sites into account, necessarily leads to restrictions in the angle of rotation of the work boom 14.

The four support feet 26 that are standing on the ground, namely VL (front left), VR (front right), HL (back left), and HR (back right), span a quadrangle, the sides l, r, v, h (left, right, front, back) of which form a tipping edge, in each instance (see FIGS. 2a and b). In order to guarantee stability, the quadrangle sides are not allowed to be exceeded toward the outside by the overall center of gravity of the system when the work boom 14 is moved. The invention makes use of the recognition that the location of the overall center of gravity within the tipping quadrangle can be monitored by means of support load sensors at the corners of the tipping quadrangle. Accordingly, a measuring element 30′, 30″ is disposed in each support leg 23, 25, which element comprises four strain gauges with a related electrical measurement circuit and operation amplifier, for example. Each measurement circuit issues a support-load-dependent measurement signal that can be sampled in predetermined time cycles, which signal is processed in computer-assisted evaluation electronics. For reasons of reliability, two redundant measuring elements with the related measurement circuit are disposed in each support leg.

In the support leg 23 shown in detail representations in FIGS. 3a and 4a to c and 5, the measuring element 30′ is situated in the region of the lower connection point 36 between the lower telescoping element 42 and the support foot 26. The telescoping element 42 is the hollow piston rod of a hydraulic piston/cylinder unit 44. At the lower end of the telescoping element 42, an accommodation 46 configured as a measuring bell is rigidly disposed, in which accommodation the measuring element 30′ configured as a force sensor is disposed, with a pressure piece 50 that faces upward on the support foot 26 axially acting on the force introduction location 48 of the element. The pressure piece 50 is mounted, with radial spring-centered play, in the accommodation 46 by means of two support rings 52′, 52″, which are disposed at an axial distance from one another, are shaped in meander shape in the circumference direction, and are spring-elastically deformable. Furthermore, the pressure piece 50 has an oval circumference groove 54 through part of which two hollow securing pins 56 that lie diametrically opposite one another and are supported on the accommodation 46 pass. The pressure piece 50 is formed onto a support foot ball 58 that is mounted in a ball-shaped bearing socket 60 of the support foot 26 that can be supported on the ground. Fundamentally, it is possible, in the sense of a kinematic inversion, to substitute the support foot ball 58 and the bearing socket 60 for one another. In this case, the pressure piece is formed onto a part that carries the bearing socket, while the support foot ball is formed onto the foot part 26 so as to project upward, and engages into the bearing socket from below.

In the exemplary embodiment shown in FIG. 3a, the measuring element 30′ is connected with externally disposed measurement electronics by way of a cable 62 that is passed to the outside through a gap region between the lower telescoping element 42 and the support foot 26. In the exemplary embodiment shown in FIG. 4a to c, the accommodation 46 is followed by a housing 63 that reaches into the cavity of the lower telescoping element 42, in which housing the boards of measurement electronics 64 connected with the force sensor of the measuring element 30′ are disposed. The data evaluated in the measurement electronics 64, which have already been digitalized, if necessary, are passed to the outside by way of a data line 66 or by way of a radio link. In addition, a power supply line 68 that is connected with the measurement electronics and comes from the outside is connected with the housing 63. The power lines and data lines 62, 66, 68 can be integrated in a folded bellows, not shown, on the outside of the support leg 23, which bellows protects the support leg from dirt that might enter.

In the exemplary embodiment according to FIG. 5, the measuring element 30′ situated in the accommodation 46, which element contains two redundant force sensors, stands in connection with amplifier and transformer electronics 64′, 64″ and a transmission unit 90′, 90″ situated in the lower telescoping element 42. Here, the power supply is provided by way of batteries 92′, 92″, which are present in double form, just like the force sensors of the measuring element 30′, the amplifier and transformer electronics 64′, 64″, and the transmission unit 90′, 90″. The transmission antennas 94′, 94″ supplied by way of the transmission unit 90′, 90″ are disposed on the outside of the lower telescoping element 42, in the form of wire loops, in the exemplary embodiment shown. The transmission antennas 94′, 94″ are also configured in double form, for reasons of redundancy. Charging of the batteries 92′, 92″ in the lower telescoping element 42 takes place by way of an induction section, the primary coil 96 of which, to which an alternating voltage can be applied, is situated at the lower end of the upper telescoping element 70, and the secondary coil 98 of which, facing the primary coil 96, is situated on the lower telescoping element 46. The two coils 96, 98 of the induction section lie against one another, by way of a small axial air gap, only when the lower telescoping element 42 is retracted, so that charging of the batteries 92′, 92″ can take place only in this state of the telescoping element 42. In this connection, the measurement electronics are not in operation, so that undisturbed charging is possible.

In the exemplary embodiment shown in FIGS. 6 and 7a to c, the measuring element 30″ is disposed in the region of the upper connection point 38 between the support outrigger 20, 24 and the upper telescoping element 70 of the support leg 25. In this connection, the upper telescoping element 70 lies axially against a force introduction location 76 on the measuring element 30″ with a pressure piece 72 in a sleeve-shaped accommodation 74 that is disposed on the support outrigger 20, 24 and faces downward, under the effect of the supporting force. The accommodation 74 has a sheathing pipe 78 rigidly connected with the support outrigger 20, 24, in which pipe the upper telescoping element 70 can be displaced axially, without hindrance, with radially spring-centered play. In this connection, the radial play between sheathing pipe 78 and upper telescoping element 70 is bridged by two spring-elastically deformable support rings 82′, 82″ that are disposed at an axial distance from one another, and shaped in zigzag manner or meander shape in the circumference direction. As can be particularly seen in FIGS. 7a and b, the upper telescoping element 70, with the pressure piece 72 that projects on its upper face side, is articulated onto the support outrigger 20, 24 by means of a wrist pin 86 that passes through the accommodation 74, transverse to the telescope axis 84, while the pressure piece 72 and the upper telescoping element 70 lie axially against one another on face-side coupling surfaces 88 that are complementary to one another and curved spherically. In this exemplary embodiment, the wrist pin 86 is simultaneously configured as a measuring element 30′. For this purpose, the wrist pin has at least one strain gauge, not shown, for determining the pin bending or the shear deformation as a measure of the supporting force (DE-A 103 49 234). The support rings 82′, 82″ that engage into circumference grooves of the upper telescoping element 70 and of the accommodation 74 ensure that the cylinder/piston unit of the support leg 25 cannot fall out of the accommodation 74, downward.

In the exemplary embodiments shown, the upper telescoping element 70 is configured as the cylinder part of a dual-action hydrocylinder, the piston of which is connected with a piston rod that forms the lower telescoping element 42.

In the exemplary embodiments according to FIGS. 3a and 7a to c, spring centering of the pressure piece 50, 72 in the accommodation 46 takes place using meander-shaped and spring-elastically deformable support rings 52′, 52″ or 82′, 82″, respectively, one of which is shown diagrammatically in FIG. 3b, as an example. The support rings having the shape of a flat cone, which are also called star springs, have a characteristic meander-like slit configuration that gives them particularly great elasticity. An activation force exerted axially on the support ring brings about an elastic change in the cone angle and thus in the diameter of the support ring. If the inside diameter of the support ring is supported, when this happens, the outside diameter increases. If, on the other hand, the outside diameter is supported, the inside diameter decreases. At the same time, an axial activation force leads to a tipping movement of the support ring. This movement is utilized to press a work piece against a longitudinal stop during bracing. An axial activation force that has been introduced is converted, without friction, into a radial force that is multiple times greater, and is used for bracing. In the exemplary embodiments shown in FIGS. 3a and 6a to c, two axial rings are combined into a spring package, in each instance.

In summary, the following should be stated: The invention relates to a mobile work device, particularly a mobile concrete pump with stability monitoring. The work device essentially consists of a chassis 10 that can be supported on a subsurface 28 with two front and two rear support outriggers 20, 24. A measuring element 30′, 30″ for determining the supporting force is disposed in the telescoping support legs 23, 25 of the support outriggers 20, 24, in each instance. For this purpose, the support legs 23, 25 have an upper telescoping element 70, in each instance, connected with the related support outrigger 20, 24 at an upper connection point 38, and, in each instance, a support foot 26 that can be supported on the subsurface 28, at a lower connection point 36, at its lower end, that can be displaced relative to the upper telescoping element. In this connection, the measuring element 30′, 30″ that is configured as a force sensor is disposed either directly at the upper connection point 38 between the support outrigger 20, 24 and the upper telescoping element 70, or in the region of the lower connection point 36 between the lower telescoping element 42 and the support foot 26. In the former case, the upper telescoping element 70 lies axially against a force introduction location 76 of the measuring element 30″ with radially spring-centered play, by means of a pressure piece 72, in a sleeve-shaped accommodation 74 that is disposed on the support outrigger 20, 24 and faces downward, under the effect of the supporting force, while in the latter case, the support foot 26 lies axially against a force introduction location 48 of the measuring element 30′, with radially spring-centered play, with a pressure piece 50 in an accommodation 46 disposed on the lower telescoping element 42, under the effect of the supporting force.

1. Mobile work device, particularly mobile concrete pump, having a chassis (10), having two front (20) and two rear (24) support outriggers (20, 24) that can be moved out from a travel position into at least one support position, and can be supported on a subsurface (28) by means of a telescoping support leg, in each instance, while raising the chassis (10), and having a measuring element (30′), in each instance, for determining the supporting force in the support legs (25), whereby the support legs (25) have an upper telescoping element (70), in each instance, connected with the related support outrigger (20, 24) at an upper connection point (38), and a lower telescoping element (42), in each instance, connected with a support foot (26) that can be supported on the subsurface (28), at a lower connection point (36), at its lower end, which lower element is displaceable relative to the upper element, and the measuring element (30″) is disposed in the region of the upper connection point (38) between the support outrigger (20, 24) and the upper telescoping element (70), wherein the upper telescoping element (70) lies friction-free axially against a force introduction location (76) of the measuring element (36″) with radially centered play, by means of a pressure piece (72) in a sleeve-shaped accommodation (74) that is disposed on the support outrigger (20, 24) and faces downward, under the effect of the supporting force.

2. Work device according to claim 1, wherein the accommodation (74) has a sheathing pipe (78) that is rigidly connected with the support outrigger (20, 24), in which pipe the upper telescoping element (70) is friction-free axially displaceable, with radially centered play.

3. Work device according to claim 2, wherein the radial play between accommodation (74) and upper telescoping element (70) is bridged by means of at least two elastically deformable support rings (82′, 82″) disposed at an axial distance from one another.

4. (canceled)

5. Work device according to claim 3, wherein the support rings (82′, 82″) are spring-elastically deformable.

6. Work device according to claim 5, wherein the spring-elastically deformable support rings (82′, 82″) are shaped in the manner of a zigzag, a lamella, or a meander, and/or are slit, in the circumference direction.

7. Work device according to claim 1, wherein the upper telescoping element (70) is articulated onto the support outrigger (20, 24), with its pressure piece (72) disposed on its upper face side, by means of a wrist pin (86) that passes through the sleeve-like accommodation (74) or the sheathing pipe transverse to the telescope axis (84), and wherein the wrist pin (86) is configured as a measuring element (30″).

8. Work device according to claim 7, wherein the pressure piece (72) and the upper telescoping element (70) are axially coupled with one another at face-side coupling surfaces (88) that are complementary to one another and curved in spherical shape.

9. Work device according to claim 7, wherein the wrist pin (86) has at least one strain gauge for determining the pin bending or the shear deformation as a measure for the supporting force.

10. Work device according to claim 1, wherein the lower telescoping element (42) carries a support foot ball that projects downward, and wherein the support foot (26) has a bearing socket to accommodate the support foot ball.

11. Work device according to claim 1, wherein the support foot (26) carries a support foot ball that projects upward, and wherein the lower telescoping element (42) has a bearing socket to accommodate the support foot ball.

12. Mobile work device, particularly mobile concrete pump, having a chassis (10), having two front and two rear support outriggers (20, 24) that can be moved out from a travel position into at least one support position, and can be supported on a subsurface (28) by means of a telescoping support leg (23), in each instance, while raising the chassis, and having a measuring element (30′), in each instance, for determining the supporting force in the support legs (23), whereby the support legs (23) have an upper telescoping element (70), in each instance, connected with the related support outrigger (20, 24) at an upper connection point (38), and a lower telescoping element (42), in each instance, connected with a support foot (26) that can be supported on the subsurface (28), at a lower connection point (36), at its lower end, which lower element is displaceable relative to the upper element, and whereby the measuring element (30′) is disposed in the region of the connection point (36) between the lower telescoping element (42) and the support foot (26), wherein the support foot (26) lies friction-free axially against a force introduction location (48) of the measuring element (30′) with radially centered play, by means of a pressure piece (50) in an accommodation (46) that is disposed on the lower telescoping element (42), under the effect of the supporting force (FIG. 3a).

13. Work device according to claim 12, wherein the accommodation (46) forms a measuring bell that is rigidly connected with the lower telescoping element (42), wherein the support foot (26) has a support foot ball (58) mounted in a bearing socket (60), and wherein the pressure piece (50) is formed onto the support foot ball (58) or onto the bearing socket (60), engages friction-free into the accommodation (46) from below, with radially centered play, and there lies axially against the measuring element (30′) under the effect of the supporting force, and is secured to prevent it from falling out.

14. Work device according to claim 13, wherein the radial play between pressure piece (50) and accommodation (46) is bridged by means of at least two elastically deformable support rings (52′, 52″) disposed at an axial distance from one another.

15. Work device according to claim 14, wherein the support rings (52′, 52″) are spring-elastically deformable.

16. Work device according to claim 15, wherein the elastically deformable support rings (52′, 52″) are shaped in the manner of a zigzag, a lamella, or a meander, and/or are slit, in the circumference direction.

17. Work device according to claim 13, wherein the pressure piece (50) has a circumferential groove (54) that is partly penetrated by two securing pins (56) that lie diametrically opposite one another and are supported on the accommodation (46).

18. Work device according to claim 12, wherein the measuring element (30′) has at least one force sensor to which the supporting force is applied by way of the pressure piece (50).

19. Work device according to claim, in that claim 1, wherein the measuring element (30′) has measurement electronics (64) that are connected with power supply and/or data lines (66, 68) that are passed to the outside.

20. Work device according to claim 19, wherein the lower telescoping element (42) is covered by a spiral-shaped folded bellows in which cables for the power supply and/or the data transmission are integrated.

21. Work device according to claim 1, wherein the measuring element (30′) is connected with measurement electronics (64) that have a transmitter or a transmission receiver for wireless data transmission.

22. Work device according to claim 21, wherein each measuring element (30′) has two redundant force sensors with measurement electronics and transmitter(s) for data transmission.

23. Work device according to claim 21, wherein each measuring element (30′) or each redundant force sensor with measurement electronics has a rechargeable battery (92′, 92″) assigned to it.

24. Work device according to claim 21, wherein the transmitter (90′, 90″) is configured as a radio transmitter, the transmission antenna (94′, 94″) of which is disposed on one of the telescoping elements (42) of the support leg, preferably on the support foot (26).

25. Work device according to claim 23, wherein an inductive power supply segment (96, 98) connected with an alternating current source on the primary side and with the battery (92′, 92″), by way of a charging circuit, on the secondary side, is disposed between the telescoping elements (42, 70) of the support legs (23, 25).

26. Work device according to claim 25, wherein the inductive power supply segment has primary and secondary coils (96, 98) that are disposed on one of the telescoping elements (42, 70), in each instance, and are activated only in the retracted state of the telescoping elements (42, 70).

27. Work device according to claim 1, wherein one of the telescoping elements (70) is configured as a cylinder part of a dual-action hydrocylinder, the piston of which is connected with a piston rod that forms the other telescoping element (42).

28. Work device according to claim 27, wherein the upper telescoping element (70) forms the cylinder part and the lower telescoping element (42) forms the piston rod of the hydrocylinder.
